(19) United States
(12) Patent Application Publication
(10) Pub. No.: US 2019/0385166 A1
(43) Pub. Date: Dec. 19, 2019

(54) SPEND LIMIT ALERT SYSTEMS AND METHODS

(71) Applicant: MASTERCARD INTERNATIONAL INCORPORATED, Purchase, NY (US)

(72) Inventor: Marthom Daetz, Valley Park, MO (US)

(21) Appl. No.: 16/011,379

(22) Filed: Jun. 18, 2018

(51) Int. Cl. G06Q 20/40; G06F 17/30

(52) U.S. Cl. CPC G06Q 20/405; G06F 17/30864

(57) ABSTRACT

A spend limit (SL) computing device is described herein. The SL computing device is programmed to receive transaction data from a payment processing network and obtain, from the transaction data, a user account, a transaction amount, and a spend amount. The SL computing device may retrieve a spend limit associated with the user account from a spend limit database, retrieve a reset time associated with the spend limit and user account from a reset time database, and retrieve a current balance associated with the user account from a balance database. The SL computing device may update the current balance database with a new balance, determined using the current balance and the transaction amount, convert the spend limit, reset time, and new balance into a visualization for the user account, and transmit the visualization to a user computing device to cause the visualization to be displayed on the user computing device.

### BACKGROUND

This invention relates generally to fraud prevention systems and more particularly, to a network-based system and method for monitoring activity, configuring security requirements for transactions, and alerting a user to a current spend limit.

Detecting fraudulent, unexpected, or unauthorized transfers of resources oftentimes requires continuous monitoring of inventory or resource levels. In the absence of constant monitoring, fraud or theft may lead to undetected, unauthorized transfers. Even in legitimate exchanges, engaging in transfers that exceed existing resource levels is possible. In some situations, physical verification of current resource levels is required. In other cases, verification procedures conducted by an operator is needed prior to an exchange.

Systems designed to monitor changes in resource levels often lack convenient and accessible user interfaces. For example, displaying numerical values of current or available resource levels may require an operator to be physically present and observing the display. Simply alerting the operator to a change provides a marginal improvement to the process, but is fraught with nuisance activities such as repeatedly verifying and confirming transfers known to be within acceptable limits. In addition, verifying exchanges may require additional cumbersome security authentication procedures.

For example, in the case of a payment transaction, parties may wish to engage in a payment transaction but do not know if they have enough funds in their account to cover the transaction. In other situations, users may have lost their payment card or their payment card may have been stolen or otherwise compromised. In any of these cases, limits on spending amounts, defined by the issuing financial institution, prevent fraudulent or excessive charges to the parties and their corresponding financial institution. Users that have engaged in a variety of transactions within a certain period, however, have difficulty determining if they are near the limit that will trigger automatic security protection and deny the transaction. A user attempting to engage in a transaction that exceeds the limit may have their transaction denied.

To prevent potentially embarrassing situations from arising, a convenient way that allows parties engaging in transactions to see that they are nearing their spend limit while retaining security protections is required. In addition, user interfaces must be automatically updated after a transaction is completed. Furthermore, a system that allows a party to exceed limits without triggering an automatic denial is needed.

### BRIEF DESCRIPTION

In one aspect, a spend limit (SL) computing device is provided. The SL computing device includes a processor in communication with a memory. The processor is programmed to receive to receive transaction data from a payment processing network and obtain, from the transaction data, a user account, a transaction amount, and a spend amount. The SL computing device may retrieve a spend limit associated with the user account from a spend limit database, retrieve a reset time associated the spend limit and user account from a reset time database, and retrieve a current balance associated with the user account from a balance database. The SL computing device may update the current balance database with a new balance, determined using the current balance and the transaction amount, convert the spend limit, reset time, and new balance into a visualization for the user account, and transmit the visualization to a user computing device to cause the visualization to be displayed on the user computing device.

In another aspect, a computer-implemented method for monitoring and controlling spend limits using a spend limit (SL) computing device is provided. The method is implemented using a SL computing device including one or more processors in communication with one or more memory devices. The method includes receiving transaction data from a payment processing network and obtain, from the transaction data, a user account, a transaction amount, and a spend amount. The method also includes retrieving a spend limit associated with the user account from a spend limit database, retrieving a reset time associated the spend limit and user account from a reset time database, and retrieving a current balance associated with the user account from a balance database. The method also includes updating the current balance database with a new balance, determined using the current balance and the transaction amount, converting the spend limit, reset time, and new balance into a visualization for the user account, and transmitting the visualization to a user computing device to cause the visualization to be displayed on the user computing device.

In a further aspect, at least one non-transitory computer-readable storage medium having computer-executable instructions embodied thereon is provided. When executed by a spend limit (SL) computing device, which includes at least one processor in communication with at least one memory, the computer-executable instructions cause the at least one processor to receive transaction data from a payment processing network and obtain, from the transaction data, a user account, a transaction amount, and a spend amount. The computer-executable instructions also cause the at least one processor to retrieve a spend limit associated with the user account from a spend limit database, retrieve a reset time associated the spend limit and user account from a reset time database, and retrieve a current balance associated with the user account from a balance database. The computer-executable instructions also cause the at least one processor to update the current balance database with a new balance, determined using the current balance and the transaction amount, convert the spend limit, reset time, and new balance into a visualization for the user account, and transmit the visualization to a user computing device to cause the visualization to be displayed on the user computing device.

### BRIEF DESCRIPTION OF THE DRAWINGS

FIGS. 1-10 show example embodiments of the methods and systems described herein.

FIG. 1 is a schematic diagram illustrating an example spend limit computer system for monitoring, displaying, and controlling spend limit security protocols in accordance with one embodiment of the present disclosure.

FIG. 2 illustrates an example data flow diagram illustrating the flow of data between various components of the spend limit computer system shown in FIG. 1.

FIG. 3 illustrates an example of a user computing device displaying a visualization with high available spend converted from data received by the spend limit computer system shown in FIG. 1.

FIG. 4 illustrates an example of a user computing device displaying a visualization with low available spend converted from data received by the spend limit computer system shown in FIG. 1.

FIG. 5 illustrates an example embodiment, of a user computer device used to display a visualization converted from data received by the computer system shown in FIG. 1.

FIG. 6 illustrates an example data flow diagram illustrating the flow of data between the spend limit computer device and the parties shown in FIG. 1.

FIG. 7 shows an example data flow diagram illustrating the flow of data between components of the spend limit computer system shown in FIG. 1 during override configuration.

FIG. 8 shows an example data flow diagram illustrating the flow of data between various components of the computer system shown in FIG. 1 when a spend limit is exceeded.

FIG. 9 is a flowchart of an example method of processing transaction data by the computing device shown in FIG. 1.

FIG. 10 is a flowchart of an example method for configuring an override by the computing device shown in FIG. 1.

Like numbers in the Figures indicate the same or functionally similar components.

### DETAILED DESCRIPTION

The system and methods described herein enable a user to view a spend limit associated with a payment account, a current balance on the account, and a time period for which the spend limit will remain in effect and/or be refreshed. In particular, the system displays the information in a visual format (e.g., a gradient, chart, table of numbers, etc.) to the user and monitors transaction activity detected on a network (e.g., a payment processing network), continuously (e.g., in real time) or periodically updating the account information with new information based on payment transactions being processed over the payment processing network. In the event of excessive transaction amounts, the system automatically denies certain transactions but may provide an override portal to enable the user to authorize a denied transaction, or to authorize exceeding the limit prior to an expected transaction.

In the example embodiment, a spend limit (SL) computer system includes a spend limit (SL) computing device having at least one processor in communication with at least one memory device. The SL computing device is configured to receive and process transaction data and account configuration data. The SL computing device monitors transactions across a system or network, such as a payment processing network, by being in network communication with a payment processing computing device of the payment processing network. The SL computing device may communicate with a user computing device or website to display the status of a user's current balance, spend limit, and reset time. The electronic display will indicate to the user a payment amount that is available to the user before an automatic transaction denial will occur. This will allow the user to avoid engaging in such a transaction where the purchase amount of the item being purchased is more than the remaining available spend limit for the user on the account. The system also allows the user to be alerted to cases of payment card fraud or theft after detecting transactions that may exceed the limit. As discussed below in further detail, the overall spend limit for a predefined period of time is set by at least one of the issuer of the payment card and the legitimate cardholder of the payment card.

The SL computing device transmits configuration information and transaction data to a user computing device or website that will display an indication or visualization to the user. The configuration information identifies how the SL computer system is configured for the user. The transmitted configuration information may include an overall spend limit amount indicating a maximum amount that the user may spend for a given period of time (e.g., 1 day, 2 days, 1 week, single transaction, 5 transactions, etc.). The configuration information may also include the time period for which the spend limit is applicable. The configuration information may also include the current amount of spending that the user has already transferred or engaged in, or in other words, the current balance. For example, the visualization may include a current balance and the available spend limit. The current balance would indicate to the user the total amount of transactions that have been engaged in during the time period. If the user has purchased $100 worth of products in the morning and $200 worth of products in the afternoon, the current balance is $300 for a 24-hour time period. If the particular account is assigned a $1000 spend limit for the 24-hour time period, the visualization may also reflect $700 in available spending. Alternatively or additionally, other data may be displayed that may be helpful to the user to identify cases of fraud. For example, the most recent transactions on the account, the location of the most recent transactions, the time of the most recent transactions, or the amounts of the most recent transactions may be displayed.

In an example embodiment, the SL computing device is configured to transmit updated reset time (e.g., when the available spend limit is reset), current balance, and spend limit data to a user computing device communicatively coupled with a network capable of receiving data transmitted by SL computing device. In some embodiments, the user computing device may be a mobile phone or tablet, a website displayed on a personal computer, a television set, a radio or other media player. In some embodiments, the user computing device may be integrated into a vehicle, home, office, or other structure configured to include a method of displaying information to a user. In some embodiments, a display may be present at or in a merchant location and configured to identify a particular user and communicate with SL computing device to determine and display a message or warning to indicate whether potential purchases may trigger an automatic denial.

In the example embodiment, the SL computing device is configured to be used when a user, such as a cardholder, is issued a payment card. The financial institution issuing the payment card (e.g., issuer bank) may then register the user and the account information with the SL computing device. The registration may include the user's identification information and user account information. The SL computing device may communicate with the issuing financial institution to receive data regarding the cardholder's account. For example, the user may use a user computing device or website to request, from the SL computing device, the current status of the user's payment card spend limit. The SL computing device may then transmit the request to the user's issuing financial institution and receive a response from the issuing financial institution and update its memory accordingly. The spend limit data may then be transmitted back to the user computing device or website.

In another embodiment, the user computing device may have a computer app such as MASTERPASS® by Mastercard or another digital wallet service for a mobile device such as a smartphone. The app may display the overall spend limit as a number. In the example embodiment, the SL computing device causes the app to display a single bar with a gradient of colors where the color green indicates a capacity for future payment transactions that a user may engage in without triggering an automatic transaction denial, and the color red indicates expended or consumed capacity of the total spend limit for the time period. In some embodiments, the gradient encompasses the entire app or payment card. For example, if a user has reached their spend limit for the time period, the entire display may be red, or if the user has not engaged in any transactions for the time period, the entire display or payment card may be green. In some embodiments, the user may select other colors or shades or combination or colors or shades to represent varying levels or degrees represented by the gradient. In some embodiments, the display may be represented by other visualization shapes, structures, and effects other than a gradient within a bar (e.g., a speedometer, odometer, pie chart, pyramid, etc.) In some embodiments, the visualization effects may by dynamic. For example, the visualization may partially or wholly flash if the spend limit is nearly reached or if the amount of transactions for the time period has exceeded a predefined threshold.

In the example embodiment, as the user engages in transactions over the time period the gradient will be updated to reflect additional transactions. For example, the green indication may decrease while the red indication may increase. When the user has engaged in transactions with accumulated sum total near the overall spend limit, the amount of red on the gradient may fill nearly the entire gradient to give the user a visual indication that they are near their overall spend limit. The display may also appear in the form of a pie chart, bar graph, or other methods of data visualization convenient for a user to interpret. In some embodiments, numerical values may be overlaid on the visualization to further aid in allowing a user to quickly understand the current balance in relation to the spend limit for the associated account.

In another embodiment, if the user engages in a payment transaction, the SL computing device detects the payment transaction on the payment processing network and automatically requests updated data from the issuing financial institution. So, the SL computing device may be in network communication with the payment processor and as transactions are being processed, the SL computing device may parse certain authorization messages (e.g. ISO® 8583 compliant messages and ISO® 20022 compliant messages). The SL computing device is programmed to detect transactions initiated by the cardholder using the payment account. Thus, the SL computing device is able to update the available spend limit of the user account in real time as the transactions are being processed. The updated data is then transmitted to the user. In some embodiments, the SL computing device may “push” the data, or automatically transmit updated spend limit data, to the user's app or website. In another embodiment, the SL computing device may update the memory accordingly and hold the updated data until the user launches an app or requests the updated spend limit data via a website before transmitting the updated spend limit data to the user.

The payment network may be configured to process authorization messages, such as ISO 8583 compliant messages and ISO 20022 compliant messages. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In certain embodiments the issuing financial institution may transmit additional data to the SL computing device. The additional data may include information such as the overall spend limit, the duration of the spend limit, the time remaining before the spend limit resets, an amount previously spent within the time period, and other useful data that will allow the user to track spending behavior. For example, in a given 24-hour time period, if the overall spend limit is $1000, and the user frequently spends $900 in the time period, the user may wish to increase the overall spend limit. In another example, the user may find their spending behavior to necessitate increasing the time period to two days. When the financial institution updates the SL computing device with the additional data, the SL computing device may push or otherwise update the user's computer device or update a website without repeated requests to the issuing financial institution thereby reducing network load and improving response times. For example, a new transaction detected on the payment processing network for the user will be transmitted to the SL computing device. The SL computing device may then calculate or process the new data and update the user's current status automatically avoiding unnecessary requests to the financial institution.

In some embodiments, the user may request an override of the overall spend limit prior to an expected transaction. The user may initiate a request to the SL computer system via a website or an app on a user computing device. The SL computer system may then request from the user additional identification to authenticate the user. Once the user is authenticated, the SL computing device may transmit to the issuing financial institution an override request. In some embodiments, the SL computer system may be configured to automatically grant an override request without receiving authorization from the issuing financial institution. In other embodiments, an override may include a predetermined limit where a request for an override of a lower amount may be granted by the SL computer system and a higher amount may require authorization from the issuing financial institution. The SL computing device may then receive a response from the issuing financial institution and transmit a confirmation to at least one of the app, website, or another computer or electronic device. In some embodiments, the user may request a specific spending amount for the override. The specific amount may be defined by the user or the specific amount may be automatically transmitted when the user engages in a payment transaction at a merchant point-of-sale (POS) device. In some embodiments, the SL computing device may disable the cardholder's account and prevent additional transactions on the payment card if authorization fails.

In some embodiments, the registration of users includes opt-in informed consent of users to data usage by the SL computing system consistent with consumer protection laws and privacy regulations. In some embodiments, the enrollment data and/or other collected data may be anonymized and/or aggregated prior to receipt such that no personally identifiable information (PII) is received. In other embodiments, the system may be configured to receive enrollment data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals, or may make use of such personal information, the individuals may be provided with an opportunity to control whether such information is collected or to control whether and/or how such information is used. In addition, certain data may be processed in one or more ways before it is stored or used, so that personally identifiable information is removed.

At least one of the technical problems addressed by this system includes: (i) monitoring and detecting transactions for excessive or fraudulent transactions; (ii) viewing current payment card balances; (iii) viewing security spend limits associated with a payment card; (iv) viewing reset times for security limits; and (v) configuring overrides on spend limits.

A technical effect of the systems and processes described herein is achieved by performing at least one of the following steps: (i) receiving transaction data from a payment processing network; (ii) determining, using the transaction, a user account, a transaction amount, and a spend amount; (iii) retrieve a spend limit associated with the user account from a spend limit database; (iv) retrieve a reset time associated the spend limit and associated with the user account from a reset time database; (v) retrieve a current balance associated with the user account from a balance database; (vi) update the current balance database with a new balance wherein the new balance is determined using the current balance and the transaction amount; (vii) convert the spend limit, reset time, and new balance into a visualization for the user account; and (viii) transmit the visualization to a user computing device to cause the visualization to be displayed on the user computing device.

Described herein are computer systems such as a spend limit computer system. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, ORACLE® Database, MySQL, IBM® DB2, MICROSOFT® SQL Server, SYBASE®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

As used herein, the term “real time” refers to substantially simultaneous or near instantaneous transfer of information. The information transfer may pertain specifically to processing payment transactions or generally to data transmitted from one component and received by a second component. The transfer of information may be executed across a network or internally within a system. In the embodiments described herein, the time it takes to process a payment card transaction is executed in real time. The time period, for processing payment transactions, is measured in seconds or in some cases, less than seconds (milliseconds).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the development and sale of financial instruments associated with a financial analytics of a geographical sector.

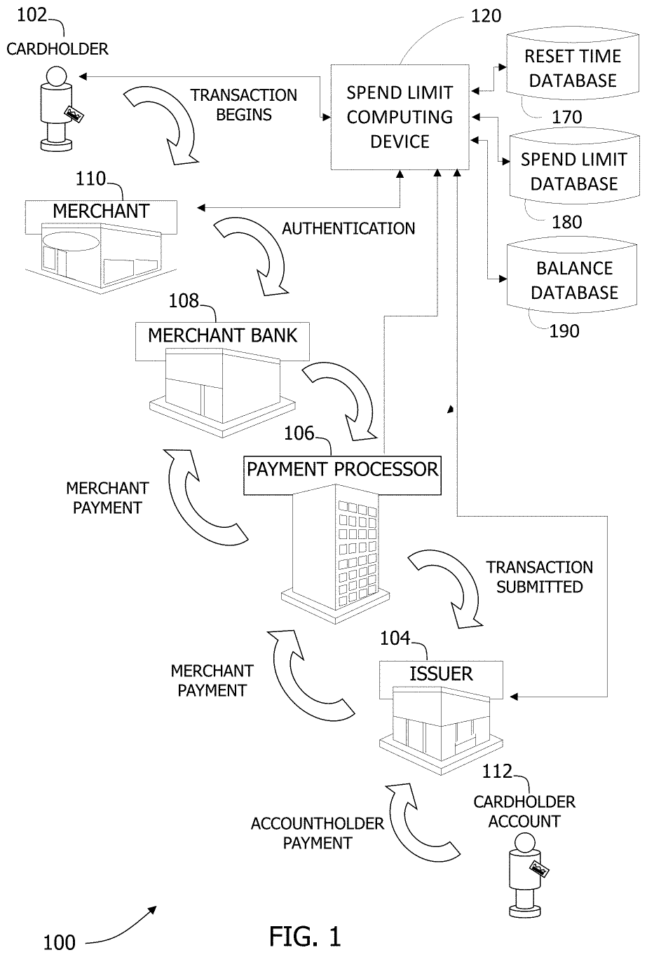

FIG. 1 is a schematic diagram illustrating an example multi-party payment card processing system 100 for enabling payment transactions between merchants 110, cardholders 102, and issuer banks 104. Embodiments described herein may relate to a transaction card system, such as a credit card payment system using MASTERCARD® interchange network. The MASTERCARD® interchange network is a set of proprietary communications standards promulgated by Mastercard International Incorporated for the exchange of financial transaction data and the settlement of funds between financial institutions that are members of Mastercard International Incorporated. (MASTERCARD® is a registered trademark of MasterCard International Incorporated located in Purchase, N.Y.).

In the payment card processing system, a financial institution called the “issuer” 104 issues a transaction card or electronic payments account identifier, such as a credit card, to a consumer or cardholder 102, who uses the transaction card to tender payment for a purchase from a merchant 110. To accept payment with the transaction card, merchant 110 must normally establish an account with a financial institution that is part of the financial payment system. This financial institution is usually called the “merchant bank,” the “acquiring bank,” or the “acquirer” 108. Cardholder 102 tenders payment for a purchase with a transaction card and merchant 110 requests authorization from a merchant bank 108 for the amount of the purchase. The request may be performed over the telephone, but is usually performed through the use of a point-of-sale terminal, which reads cardholder's 102 account information from a magnetic stripe, a chip, or embossed characters on the transaction card and communicates electronically with the transaction processing computers of merchant bank 108. Alternatively, merchant bank 108 may authorize a third party to perform transaction processing on its behalf. Alternatively, the point-of-sale terminal will be configured to communicate with the third party. Such a third party is usually called the “payment processor,” the “acquiring processor,” or the “third party processor” 106.

Using an interchange network, computers of merchant bank 108 or payment processor 106 may communicate with SL computing device 120 to determine if a spend limit security system has been enabled for the account associated with cardholder 102. SL computing device may communicate with issuer 104 to determine if a spend limit security system has been enabled. SL computing device 120 may communicate with spend limit database 180, reset time database 170, and balance database 190 to determine if the requested transaction will exceed the spend limit and trigger an automatic transaction denial. SL computing device 120 may communicate the determination to merchant 110, issuer 104, and cardholder 102. Additionally, or alternatively, where the transaction does not exceed the spend limit or trigger a transaction denial, SL computing device 120 may communicate with issuer bank 104 to determine whether cardholder's 102 account is in good standing and whether the purchase is covered by cardholder's 102 available credit line. Based on these determinations, the request for authorization will be declined or accepted. If the request is accepted, an authorization code is issued to merchant 110.

When a request for authorization is accepted, the available credit line of cardholder account 112 is decreased. Normally, a charge for a payment card transaction is not posted immediately to cardholder's 102 account 112 because bankcard associations, such as Mastercard International Incorporated, have promulgated rules that do not allow merchant 110 to charge, or “capture,” a transaction until goods are shipped or services are delivered. However, with respect to at least some debit card transactions, a charge may be posted at the time of the transaction. When merchant 110 ships or delivers the goods or services, merchant 110 captures the transaction by, for example, appropriate data entry procedures on the point-of-sale terminal. This may include bundling of approved transactions daily for standard retail purchases. If cardholder 102 cancels a transaction before it is captured, a “void” is generated. If cardholder 102 returns goods after the transaction has been captured, a “credit” is generated. If a transaction is successfully completed SL computing device 120 may update balance database 190 accordingly.

After a purchase has been made, a clearing process occurs to transfer additional transaction data related to the purchase among the parties to the transaction, such as merchant bank 108, payment processor 106, and issuer bank 104. More specifically, during and/or after the clearing process, additional data, such as a time of purchase, a merchant name, a type of merchant, purchase information, user account information, a type of transaction, itinerary information, information regarding the purchased item and/or service, and/or other suitable information, is associated with a transaction and transmitted between parties to the transaction as transaction data, and may be stored by any of the parties to the transaction. In an example embodiment, when cardholder 102 purchases tickets to a mobile event, such as a carnival, a concert, a fair, and/or another type of festival, at least partial itinerary information is transmitted during the clearance process as transaction data. When payment processor 106 receives the itinerary information, payment processor 106 routes the itinerary information to SL computing device 120.

For debit card transactions, when a request for a personal identification number (PIN) authorization is approved by the issuer, SL computing device 120 may determine if the charge exceeds the spend limit. If the SL computing device 120 determines the spend limit is not exceeded, cardholder account 112 is decreased. The charge is posted immediately to cardholder account 112. The payment card association then transmits the approval to the acquiring processor for distribution of goods/services or information, or cash in the case of an automated teller machine (ATM).

After a transaction is authorized and cleared, the transaction is settled among merchant 110, merchant bank 108, and issuer bank 104. Settlement refers to the transfer of financial data or funds among merchant's 110 account, merchant bank 108, and issuer bank 104 related to the transaction. Usually, transactions are captured and accumulated into a “batch,” which is settled as a group. More specifically, a transaction is typically settled between issuer bank 104 and payment processor 106, and then between payment processor 106 and merchant bank 108, and then between merchant bank 108 and merchant 110.

In some embodiments, cardholder 102 registers one or more payment cards with a digital wallet such as APPLE PAY™, or MASTERPASS™. Having done this, cardholder 102 can interact with a participating online merchant 110. At the check-out stage, online merchant 110 displays a button on the merchant website which cardholder 102 can click on in order to make a payment using the user's digital wallet. Online merchant 110 then redirects the user to a “switch” operated by payment processor 106. Using a cookie located on the user's computer, the “switch” is able to determine which wallet-hosting server hosts a wallet associated with cardholder 102. The switch then establishes a connection between the user's computer and the appropriate wallet-hosting system, which presents cardholder 102 with a sign-in page (e.g., as a pop-up window), where there is an authentication process (e.g., entry of a pre-agreed password). This log-in process may use the same login credentials (e.g., password) which the user also uses to obtain access to other online banking activities.

The wallet-hosting system then securely transfers the user's payment information to the online merchant's domain. The merchant's domain submits the user's payment information to merchant bank 108 for a separate authorization process in which the acquiring domain communicates with issuer bank 104 to ask the bank to authorize the transaction. Issuer bank 104 may then communicate with SL computing device 120 to determine if the transaction exceeds the spend limit. Thus, cardholder 102 is not required to enter their card details (except at the stage of initially registering with the wallet-hosting system), and the online transaction process is streamlined with appropriate security verification while maintaining only a single redirection, and consistent branding for the entire payment process, irrespective of online merchant 110, payment processor 106, merchant bank 108, or issuer 104.

In some embodiments, a unique identifier is provided to cardholder 102. The unique identifier is different from the cardholder's account number. In these embodiments, payment processor 106 stores the unique identifier associated with cardholder account 112. When payment processor 106 receives the unique identifier in a transaction, payment processor 106 determines the associated cardholder account 112 and transmits the appropriate information to SL computing device 120 for security verification to process the payment transaction.

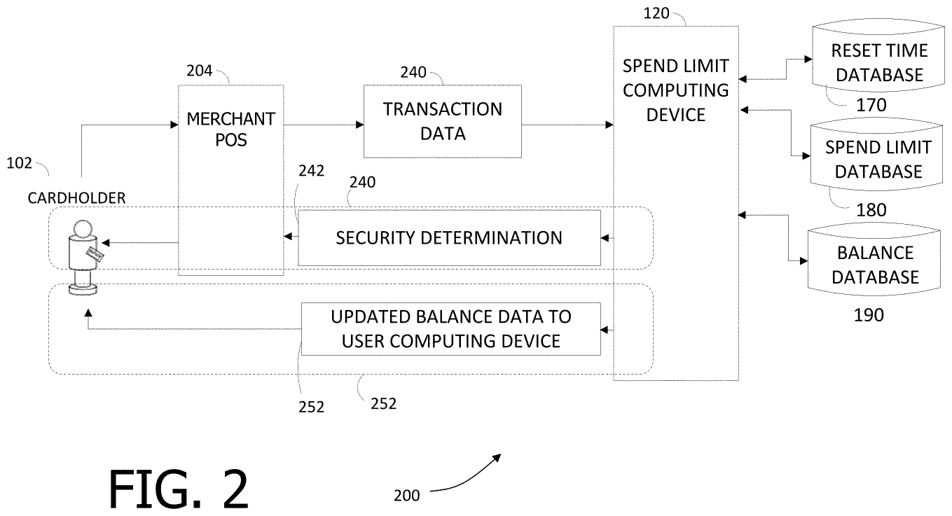

FIG. 2 is an example data flow diagram illustrating the flow of data between various components of the computer system shown in FIG. 1. In the illustrated embodiment, SL computing device 120 (also shown in FIG. 1) receives transaction data 240 from a merchant POS 204 in a transaction initiated by cardholder 102 (also shown in FIG. 1).

In some embodiments, SL computing device 120 is operatively coupled to a storage device. In some embodiments, the storage device may be a reset time database 170, a spend limit database 180, or a balance database 190. SL computing device 120 may communicate with any of time database 170, spend limit database 180, or balance database 190 via an interface capable of providing SL computing device 120 with access to any of the storage devices. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing SL computing device 120 with access to any of the storage devices.

In the example embodiment, SL computing device 120 retrieves a reset time from reset time database 170 (also shown in FIG. 1), a spend limit from spend limit database 180 (also shown in FIG. 1), and a current balance from balance database 190 (also shown in FIG. 1). The SL computing device 120 may determine, using transaction data 240, the reset time, the spend limit, and the current balance, whether the transaction will trigger an automatic transaction denial. SL computing device may transmit a security determination 242 granting or denying the transaction to the merchant. In the example embodiment, SL computing device 120 will update balance database 190. Additionally, or alternatively, SL computing device 120 will transmit to a user computing device an updated balance 252 after a successful transaction.

In another embodiment, cardholder 102 may be ready to engage in a transaction at merchant POS 204. Cardholder 102 may determine, at least by viewing the spend limit, reset time, and current balance data on a user device, that the current balance is near the spend limit or approximately near the spend limit such that an additional transaction will lead to an automatic denial by the system. In such situations cardholder 102 may initiate an override before engaging in the transaction as explained in more detail below. In another example embodiment, cardholder 102 may decide to wait before engaging in any additional transactions. As shown in FIG. 2, SL computing device retrieves a reset time for the account associated with cardholder 102 and at the expiration of the time period, clears the balance stored in balance database 190. SL computing device 120 may transmit updated balance data to the user computing device at which point cardholder 102 may engage in transactions again without triggering automatic transaction denials.

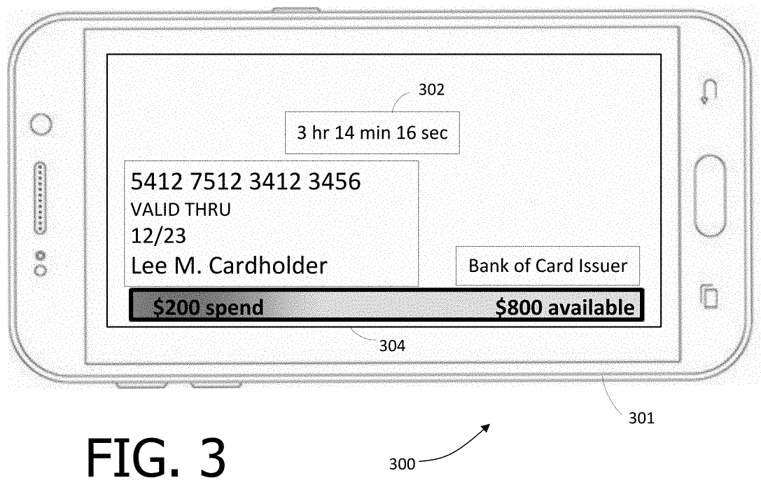

FIG. 3 illustrates an example of a user interface 300 using a user computing device 301 to display a visualization converted from data received by the computer system shown in FIG. 1. User computing device 301 includes a processor, a memory device, and a transmitter for transmitting card data to merchant POS 204 (shown in FIG. 2), for example. SL computing device 120 (shown in FIG. 1) may then receive transaction data through payment processor network 106 (shown in FIG. 1). User computing device 301 may include mobile phones, smartphones, personal digital assistants (PDAs), iPhone® (iPhone is a registered trademark of Apple, Incorporated located in Cupertino, Calif.), Android® (Android is a registered trademark of Google Incorporated, located in Mountain View, Calif.), and/or any device capable of executing stored computer-readable instructions. User computing device 301 is also wirelessly connected to a network such that it is capable of receiving data from SL computing device 120. The communication in the exemplary embodiment is being performed using the Internet, however, any other wide area network (WAN) type communication can be utilized in other embodiments, i.e., the systems and processes are not limited to being practiced using the Internet.

User computing device 301 also includes at least one media output component for presenting information to cardholder 102 (shown in FIG. 1) such as a display device, a liquid crystal display (LCD), organic light emitting diode (OLED) display, or “electronic ink” display, or an audio output device, a speaker or headphones. User computing device 301 may receive data from SL computing device 120 including a reset time, a current balance, and a spend limit.

In the exemplary embodiment, SL computing device 120 transmits a gradient. Gradient 304 may in the form of a horizontal bar. Gradient 304 may include a color differential spanning the width of the horizontal bar. One end of gradient 304 may include a range of colors where, for example, the color green indicates a capacity for future payment transactions and the color red indicates expended or consumed capacity of the total spend limit. A range of colors indicating a gradual shift between green and red may be displayed. In an example embodiment, gradient 304 may include numerical values indicating the balance of the associated cardholder account 112 (shown in FIG. 1) displayed. As shown in FIG. 3, $200 spend may be expended and is represented by a darker shade or red on gradient 304. The remaining spend available to cardholder 102 shows $800 in a lighter shade or green on the right side of gradient 304. In some embodiments, the overall spend limit may also be shown on user computing device 301. In the exemplary embodiment, a balance may be displayed along with a remaining availability indicating possible transactions that may be undertaken before an automatic transaction denial is triggered. In addition, a time period 302 may be displayed indicating the time remaining until the complete capacity is reset allowing the full spend limit to be used again.

In some embodiments, user computing device 301 includes an input device for receiving input from cardholder 102. The input device may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of user computing device 301. In other words, a touch screen may form a user interface for user computing device 301. User computing device 301 may also include a communication interface, which is communicatively couplable to a remote device (e.g., a merchant POS 204, shown in FIG. 2, or merchant bank 108, shown in FIG. 1). The communication interface may include, for example, a wired or wireless network adapter or a wireless data transceiver for use with a mobile phone network, Global System for Mobile communications (GSM), 3G, or other mobile data network or Worldwide Interoperability for Microwave Access (WIMAX). Cardholder 102 may interact with user computing device 301 to communicate with an override portal to initiate a security spend limit override to engage in transactions that would exceed the spend limit.

As described above, cardholder 102 engaging in a transaction with a merchant may use a n interchange network or payment processor. The computers of merchant bank 108 or the merchant processor will communicate with the computers of issuer bank 104 (shown in FIG. 1) to determine whether cardholder account 112 is in good standing and whether the purchase is covered by cardholder's 102 available credit line. SL computing device 120 will similarly determine whether the transaction triggers an automatic transaction denial. Based on these determinations, the request for authorization will be declined or accepted. If the request is accepted, an authorization code is issued to the merchant. In addition, or alternatively, SL computing device 120 will transmit an updated balance to user computing device 301. If the request is rejected, SL computing device 120 may transmit a transaction denial to user computing device 301. In some embodiments, SL computing device 120 may transmit an override request to user computing device 301. User computing device 301 may be used to authenticate an override request. In some embodiments, SL computing device 120 may transmit a message to user computing device 301 in the event of a failed authentication request. In some embodiments, SL computing device will disable cardholder account 112 and transmit a message to user computing device 301.

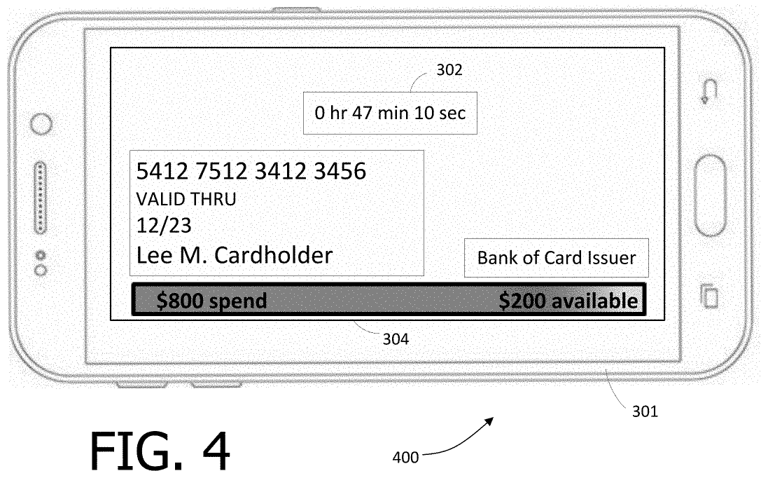

FIG. 4 illustrates an example of user interface 400 when cardholder 102 has expended more of the available spend and is closer to the overall spend limit. In the example shown, cardholder 102 has expended $800 and the darker shading or green color comprises a larger percentage of gradient 304. The $200 remaining in the available spend is shown in a lighter shade or in green and occupies a smaller portion of gradient 304. In addition, time period 302 displays 47 minutes and 10 seconds until the overall spend limit is reset. Upon reset, gradient 304 will be entirely green. In some embodiments, gradient 304 will indicate $0 spend and $1000 available or another overall spend limit value for cardholder account 112.

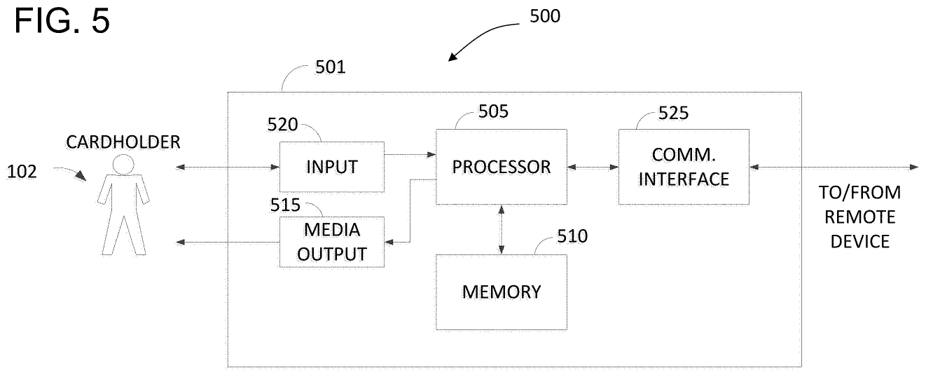

FIG. 5 illustrates an example configuration of a server system 501 such as SL computing device 120 (shown in FIG. 1) used to monitor, control, and display a visualization of balance, spend limit, and reset limit associated with cardholder account 112 (shown in FIG. 1). Server system 501 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 501, such as UNIX, LINUX, MICROSOFT WINDOWS®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 525 such that server system 501 is capable of communicating with a remote device such as a user system or another server system 501. For example, communication interface 525 may receive requests (e.g., requests to provide an interactive user interface) from a user computing device 301 (shown in FIG. 3) via the Internet.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

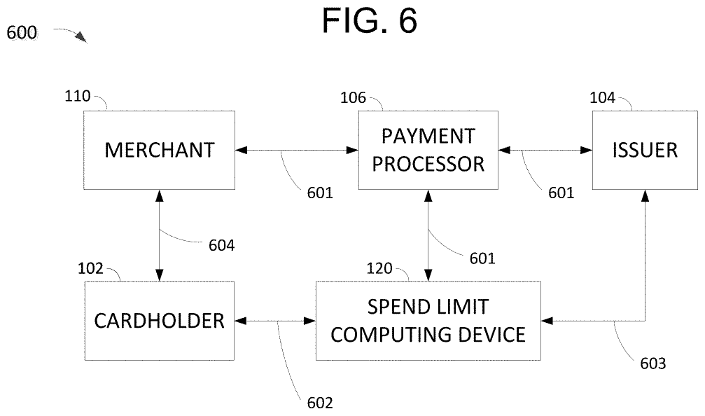

FIG. 6 shows an example data flow diagram illustrating the flow of data between various components of a spend limit (SL) computer system. The SL computer system includes SL computing device 120. The SL computer system may include cardholder 102 engaging in a transaction with merchant 110. The transaction may be executed across a communication channel 604 such as the Internet for online transactions or if in person, the transaction may be conducted using a POS as described elsewhere herein.

Upon initiation of a transaction, merchant 110 transmits details of the transaction to payment processor 106 across a payment processing network 601. Payment processor 106 transmits the transaction details to SL computing device 120 for processing. SL computing device 120 may determine that cardholder 102 has exceeded their overall spend limit for the time period. In some embodiments, SL computing device may automatically reject the transaction and notify payment processor 106 to deny the transaction. Payment processor 106 will transmit to merchant 110 the rejection. In some embodiments, SL computing device 120 may transmit an override request to cardholder 102 across a communication channel 602. Communication channel 602 may be the Internet, a Wi-Fi network, or mobile phone network. In this manner, SL computing device 120 prompt cardholder 102 if they wish to override the automatic rejection.

If cardholder 102 confirms an override request, SL computing device 120 authenticates cardholder 102 for the override. In some embodiments, SL computing device 120 may be configured to automatically grant override requests. In other embodiments, SL computing device 120 may be configured to grant only a certain number of override requests (e.g., 1 or 5 override requests before the reset occurs) or only override requests below a certain amount (e.g., $10, $100, etc.). In other embodiments, SL computing device 120 may be configured to deny override requests if requested at certain times, in certain places, or with certain merchants.

In some embodiments, SL computing device 120 may be configured to transmit the override request details to issuer 104. Issuer 104 may then grant or deny the override request and transmit the response to SL computing device 120. In some embodiments, issuer 104 may also transmit the rejection to payment processor 106. In other embodiments, SL computing device 120 may transmit the response to payment processor 106. In some embodiments, SL computing device 120 may also transmit the response from issuer 104 to cardholder 102.

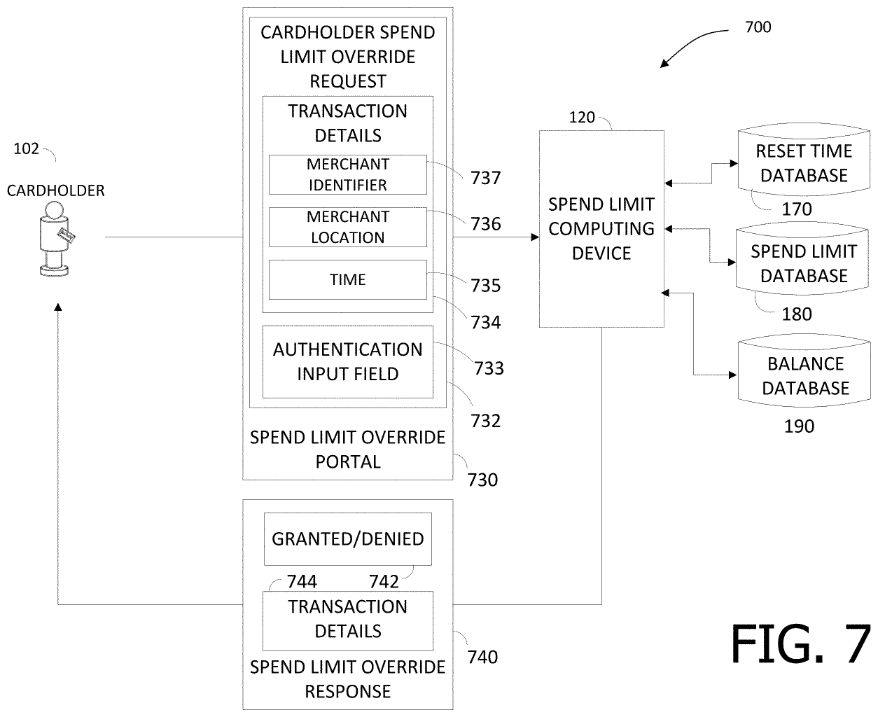

FIG. 7 shows an example data flow diagram illustrating the flow of data between various components of the computer system shown in FIG. 1 for override process 700. Cardholder 102 may use user computing device 301 (shown in FIG. 3) or website or other device to communicate with override portal 730 which permits cardholder 102 to temporarily disable the security protocols for the current transaction. Override portal 730 includes the override request 732. Override request 732 includes at least transaction details 734 and an authentication input field 733. Transaction details 734 includes at least a merchant identifier 737, merchant location 736, and a time for the transaction 735. Override portal 730 communicates with SL computing device 120 to transmit a request to prevent an automatic denial in the event the spend limit is exceeded. Override portal 730 transmits merchant identifier 737, merchant location 736, and transaction time to SL computing device 120. SL computing device 120 may then retrieve a reset time from reset time database 170, a spend limit from spend limit database 180, a current balance from balance database 190. SL computing device 120 may determine whether the transaction exceeds the spend limit for the time period and triggers an automatic transaction denial.

Cardholder 102 may initiate, using override portal 530, an override request for the transaction to SL computing device 120. SL computing device 120 may additionally receive authentication verification for the override request. Cardholder 102 may use authentication input field 733 to confirm identification of cardholder 102. SL computing device 120 may then determine if an override request is verified and transmit a result of the override request of grant or a denial 742 with transaction details 744 to user computing device 301 (shown in FIG. 3).

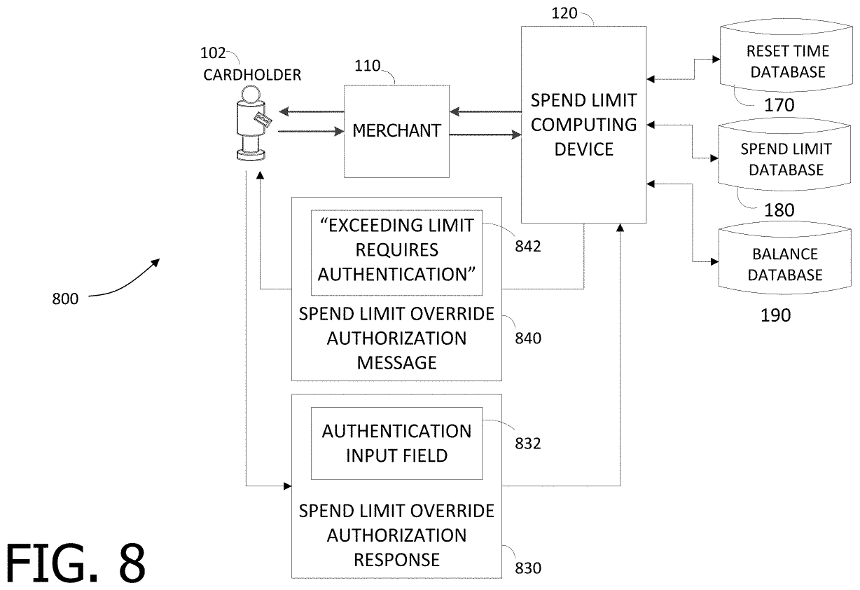

FIG. 8 shows an example data flow diagram illustrating the flow of data between various components of the computer system shown in FIG. 1 when a spend limit is exceeded. In data flow schematic 800 cardholder 102 (also shown in FIG. 1) engages in a transaction with merchant 110 (also shown in FIG. 1). The transaction may include merchant POS system 204 (shown in FIG. 2). Merchant 110 may transmit the transaction information to SL computing device 120 to determine if the transaction amount exceeds the spend limit triggering an automatic denial. SL computing device 120 (also shown in FIG. 1) may retrieve a reset time from reset time database 170, a spend limit associated with cardholder account 112 (shown in FIG. 1) from spend limit database 180, and a current balance from balance database 190. SL computing device 120 may determine that the present transaction exceeds the spend limit for the time period. SL computing device 120 may transmit to user computing device 301 (shown in FIG. 3) via an app or website or similar method, a spend limit override authorization message 840. Spend limit override authorization message 840 may include a textual message 842 for cardholder 102 indicating that “exceeding limit requires authentication” or a similar message.

In an example embodiment, SL computing device 120 may cause user computing device 301 to launch or redirect user computing device 301 to override portal 730 (shown in FIG. 7). Cardholder 102 may confirm and authenticate the override request using override portal 730. Override portal 730 may transmit to SL computing device 120 a spend limit override authorization response 830. Authorization response may include data received from cardholder 102 entered in through an authentication input field 832. SL computing device 120 may authorize the transaction when spend limit override authorization response 830 is received and confirmed. SL computing device 120 may then transmit to merchant 110 transaction grant 740 (shown in FIG. 7).

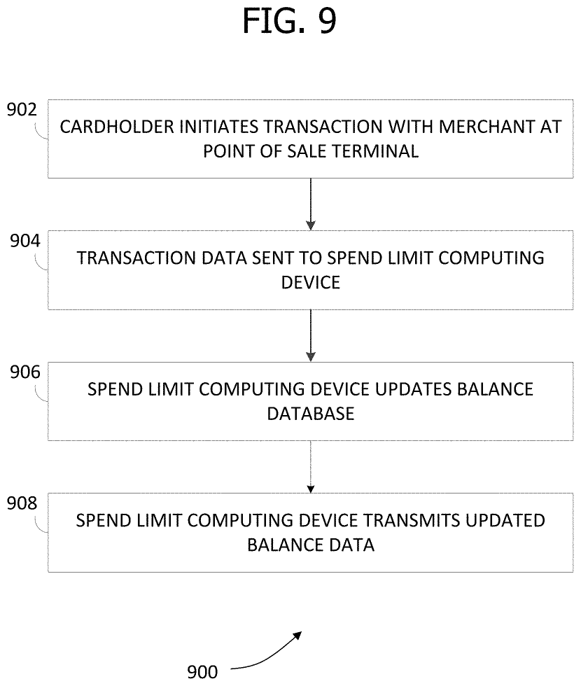

FIG. 9 is a flowchart of an example method of processing transaction data by the computing device shown in FIG. 1. One or more steps of method 900 may be implemented using SL computing device 120 (also shown in FIG. 1). Method 900 includes initiating 902 a transaction by a user at a merchant POS. Method 900 also includes receiving 904 transaction data by SL computing device 120. The transaction data includes at least a time and a transaction amount. Method 900 also includes updating 906 balance database with the balance, the new balance determined by at least using the transaction amount and the previous balance stored in the balance database. Alternatively, or in addition, updating 906 may include retrieving the current balance before determining the new balance. Method 900 also includes transmitting 908 the updated balance to a user computing device. User computing device may be a mobile phone (as shown in FIG. 3) or a similar device that cardholder 102 (shown in FIG. 1) may use to view updated balance data and spend limit information.

Method 900 also includes combining the balance data with other data including at least the spend limit data retrieved from spend limit database 180 (shown in FIG. 1) and the reset time data retrieved from reset time database 170 (shown in FIG. 1) and converting the data into a visualization. Method 900 may transmit the visualization to the user computing device to cause the user computing device to display the visualization. In some embodiments, the visualization may be a gradient of varying colors. Method 900 may include at least the balance data, spend limit, and reset time in numerical format as part of the visualization to be displayed overlaid on the gradient.

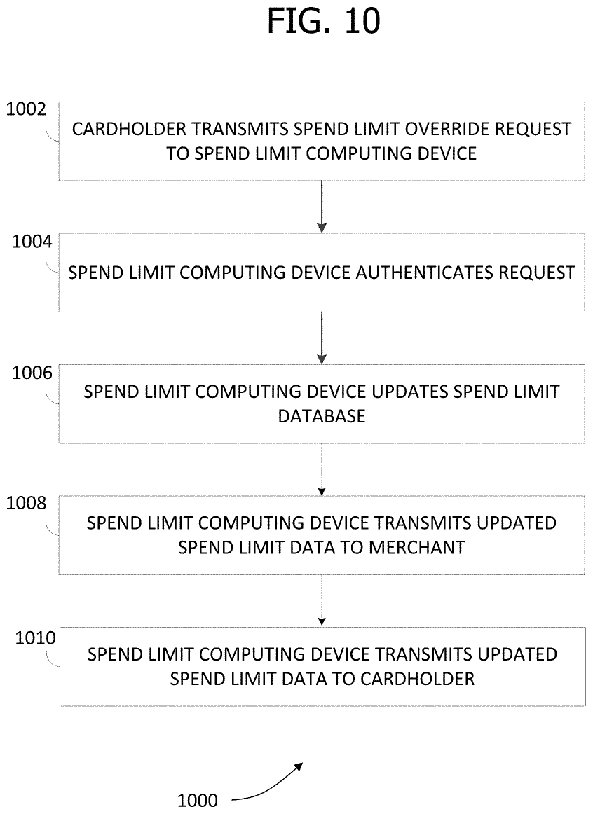

FIG. 10 is a flowchart of an example method for configuring an override by the computing device shown in FIG. 1. One or more steps of method 800 may be implemented using computing device 120 (shown in FIG. 1). Method 1000 includes cardholder 102 (shown in FIG. 1) initiating an override request by transmitting the override request to the SL computing device 1002. Cardholder 102 may use override portal 730 (shown in FIG. 7) or another method and device to initiate the override request. SL computing device 120 receives the override request from cardholder 102 associated with cardholder account 112 (shown in FIG. 1). Method 1000 may authenticate the request 1004. Upon successful authentication, method 1000 updates 1006 the spend limit database. Method 1000 also transmits to the merchant updated spend limit data 1008. Method 1000 also transmits to the cardholder the updated spend limit 1010.

Authentication of the user may include requesting additional information from cardholder 102. For example, method 1000 may include transmitting to a second user computing device a confirmation code. Authentication may be performed by requesting additional information from the second user computing device. Alternatively, or in addition, the confirmation code may be sent by SL computing device 120 as an email, sent through an automated phone system, or other automatic means of communication. Alternatively, or in addition, cardholder 102 may be redirected to a website to transmit additional conformation information. Method 1000 may include authentication using other means such as biometric data. Alternatively, or in addition to, method 1000 may authenticate cardholder 102 by using a third party authentication service. Method 1000 may additionally delete any authentication information after authentication has been completed.

Method 1000 may include updating the spend limit database. Alternatively, or in addition, method 1000 may include retrieving the spend limit with the associated cardholder account 112 before updating the spend limit database. Method 1000 may include reducing the spend limit to a number to prevent any additional transactions on cardholder account 112. Alternatively, method 1000 may include increasing the spend limit to a number to provide for the transaction amount received. Alternatively, method 1000 may maintain the current spend limit. In some embodiments, method 1000 may include storing additional information in spend limit database in addition to a spend limit. For example, method 1000 may store the override request time, geographical location of the user computing device, website and internet protocol (IP) address, method of authentication, and transaction amount that is associated with the override request. Method 1000 may use the additional information to determine if an override request should be granted.

Method 1000 includes transmitting spend limit data to the merchant associated with the transaction 1008. Merchant 110 (shown in FIG. 1) may use merchant POS (204) system to conduct the transaction. Merchant POS (204) system may automatically grant or deny the transaction based on the spent limit data transmitted by SL computing device 120. Alternatively, or additionally, the transaction may be conducted over a website or over a merchant device communicatively coupled with a network capable of receiving spend limit data transmitted by SL computing device 120.

Method 1000 also includes transmitting to user 120 updated spend limit database 1010. Cardholder 102 may use user computing device 301 (shown in FIG. 3) to receive updated spend limit data transmitted by SL computing device 120. Alternatively, or in addition, SL computing device 120 may transmit updated spend limit data to a website used by cardholder 102 or other computing device communicatively coupled with a network capable of receiving spend limit data transmitted by SL computing device 120.

Method 1000 may include combining the balance data with other data including at least the spend limit data retrieved from spend limit database 180 (shown in FIG. 1) and the reset time data retrieved from reset time database 170 (shown in FIG. 1) and converting the data into a visualization. Additionally, or alternatively, method 1000 may include other data in the visualization such as the time of the last transaction, location of the last transaction, and other relevant information to better inform cardholder 102 of potential card security breaches. Method 1000 may transmit the visualization to the user computing device to cause the user computing device to display the visualization. In some embodiments, the visualization may be a gradient of varying colors. Method 1000 may include at least the balance data, spend limit, and reset time in numerical format as part of the visualization to be displayed overlaid on the gradient.

In addition, although various elements of the computer system are described herein as including general processing and memory devices, it should be understood that the computer system is a specialized computer configured to perform the steps described herein for facilitating real time communication across different networks to update user computing devices to display user spending limits.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A spend limit (SL) computing device including at least one processor in communication with at least one memory device, said at least one processor programmed to:
receive transaction data from a payment processing network;
determine, using the transaction data, a user account, a transaction amount, and a spend amount;
retrieve a spend limit associated with the user account from a spend limit database;
retrieve a reset time associated the spend limit and associated with the user account from a reset time database;
retrieve a current balance associated with the user account from a balance database;
update the current balance database with a new balance, wherein the new balance is determined using the current balance and the transaction amount;
convert the spend limit, reset time, and current balance into a visualization for the user account; and
transmit the visualization to a user computing device to cause the visualization to be displayed on the user computing device.

2. The computing device of claim 1, wherein the visualization is a gradient of colors wherein a red portion of the gradient represents past spending and a green portion of the gradient represents available spending.

3. The computing device of claim 1, wherein the SL computing device is configured to receive an override request.

4. The computing device of claim 3, wherein the SL computing device is further configured to authenticate the user.

5. The computing device of claim 3, wherein the SL computing device is further configured to transmit the override request to an issuing financial institution.

6. The computing device of claim 3, wherein the SL computing device is further configured to grant the override request if the transaction amount is below a predefined threshold.

7. The computing device of claim 1, wherein the SL computing device is configured to automatically deny a transaction if the spend limit is exceeded by the new balance.

8. The computing device of claim 1, wherein the SL computing device is configured to receive information from an issuing financial institution, the information including a reset time for the spend limit, a spend limit amount, and a time remaining before the spend limit is reset.

9. A computer based method for providing spend limit alerts, the method implemented using a spend limit (SL) computing device including at least one processor in communication with at least one memory, said at least one processor programmed to:
receive transaction data from a payment processing network;
determine, using the transaction data, a user account, a transaction amount, and a spend amount;
retrieve a spend limit associated with the user account from a spend limit database;
retrieve a reset time associated the spend limit and associated with the user account from a reset time database;
retrieve a current balance associated with the user account from a balance database;
update the current balance database with a new balance, wherein the new balance is determined using the current balance and the transaction amount;
convert the spend limit, reset time, and new balance into a visualization for the user account; and
transmit the visualization to a user computing device to cause the visualization to be displayed on the user computing device.

10. The computer-implemented method of claim 9, wherein the visualization is a gradient of colors wherein a red portion of the gradient represents past spending and a green portion of the gradient represents available spending.

11. The computer-implemented method of claim 9, wherein the SL computing device is configured to receive an override request.

12. The computer-implemented method of claim 11, wherein the SL computing device is further configured to authenticate the user.

13. The computer-implemented method of claim 9, wherein the SL computing device is configured to automatically deny a transaction if the spend limit is exceeded by the new balance.

14. The computer-implemented method of claim 9, wherein the SL computing device is configured to receive information from an issuing financial institution, the information including a reset time for the spend limit, a spend limit amount, and a time remaining before the spend limit is reset.

15. At least one non-transitory computer-readable storage medium having computer-executable instructions for providing spend limit alerts embodied thereon, wherein when executed by a spend limit (SL) computing device including at least one processor in communication with at least one database, the computer-executable instructions cause the at least one processor to:
receive transaction data from a payment processing network;
determine, using the transaction data, a user account, a transaction amount, and a spend amount;
retrieve a spend limit associated with the user account from a spend limit database;
retrieve a reset time associated the spend limit and associated with the user account from a reset time database;
retrieve a current balance associated with the user account from a balance database;
update the current balance database with a new balance, wherein the new balance is determined using the current balance and the transaction amount;
convert the spend limit, reset time, and new balance into a visualization for the user account; and
transmit the visualization to a user computing device to cause the visualization to be displayed on the user computing device.

16. The at least one non-transitory computer-readable storage medium of claim 15, wherein the visualization is a gradient of colors wherein a red portion of the gradient represents past spending and a green portion of the gradient represents available spending.

17. The at least one non-transitory computer-readable storage medium of claim 15, wherein the SL computing device is configured to receive an override request.

18. The at least one non-transitory computer-readable storage medium of claim 17, wherein the SL computing device is further configured to authenticate the user.

19. The at least one non-transitory computer-readable storage medium of claim 15, wherein the SL computing device is configured to automatically deny a transaction if the spend limit is exceeded by the new balance.

20. The at least one non-transitory computer-readable storage medium of claim 15, wherein the SL computing device is configured to receive information from an issuing financial institution, the information including a reset time for the spend limit, a spend limit amount, and a time remaining before the spend limit is reset.
